(19) United States
(12) Patent Application Publication
(10) Pub. No.: US 2012/0045283 A1
(43) Pub. Date: Feb. 23, 2012

(54) Apparatus and Method to Remediate Contaminated Soil

(76) Inventor: Nicholas Castellano, Mesa, AZ (US)

(21) Appl. No.: 12/859,747

(22) Filed: Aug. 19, 2010

(51) Int. Cl. B09C 1/08

(52) U.S. Cl. 405/128.5

(57) ABSTRACT

An apparatus is used for remediating contaminated soil. The apparatus comprises a source of peroxone, a plurality of treatment probes for insertion into the contaminated soil, and a distribution network configured to connect the plurality of treatment probes with the source of peroxone.

### FIELD OF THE INVENTION

The invention relates to an apparatus and method for soil remediation and more particularly to the in situ remediation of soil contaminated with petroleum hydrocarbons and most particularly to a mobile device for the in situ remediation of soil contaminated with petroleum hydrocarbons using ambient air, ozone, peroxone, oxygen, and petroleum-eating bacteria.

### BACKGROUND OF THE INVENTION

Petroleum-based hydrocarbons have many uses and benefits. Gasoline, diesel, kerosene, and jet fuel are just some examples of petroleum-based hydrocarbon that are used as fuel. Petroleum-based hydrocarbons are also used to produce many non-fuel products, such as plastics, lubricants, waxes, and asphalt. Despite these uses and benefits, however, petroleum-based hydrocarbons are generally carcinogenic, flammable, and toxic to plants and animals.

All stages of petroleum-based hydrocarbon production and use, from exploration, to extraction, transportation, storage, and processing, pose a risk of harmful exposure to nearby plants and animals. A spill or leak of petroleum-based hydrocarbons commonly results in ground contamination. When spilled on solid, non-porous materials, such as a concrete floor, the spill can be remediated with relative ease. On soil and other porous surfaces, however, liquid petroleum-based hydrocarbons can penetrate the surface and permeate the soil well below the surface. Soil contaminated with petroleum-based hydrocarbons often result in a hazardous condition for anyone nearby and in serious environmental damage.

Soil contamination events can be relatively small. For example, a spill resulting from a punctured vehicle fuel tank that contaminates 64 cubic yards of soil. They can also be very large. For example, a spill resulting from a faulty well head during oil extraction or a leaking underground fuel tank that contaminates 1,000,000 cubic yards of soil. One common remediation procedure involves excavating the contaminated soil. Excavation, however, is not always feasible in the case of large contamination events. In those cases, the area may be condemned until the petroleum-based hydrocarbons naturally break down or until other remediation activities are completed. The contaminated soil may continue to pose an actual or potential risk to people and the environment for month of years after contamination.

Accordingly, it would be an advance in the art to provide a mobile soil treatment system (and method of using same) capable of non-intrusive, in situ remediation of petroleum-based hydrocarbon contaminated soil that is further capable of quickly restoring the contaminated soil quality to its natural, non-hazardous levels.

### SUMMARY OF THE INVENTION

An apparatus and method for remediating contaminated soil is presented. In one embodiment, the apparatus comprises a source of peroxone, a plurality of treatment probes for insertion into contaminated soil; and a distribution network. The distribution network is configured to connect the plurality of treatment probes with the source of peroxone and distribute peroxone from the source of peroxone to the treatment probes.

In another embodiment, the method comprises inserting one or more treatment probes into a contaminated soil field; and injecting, a first treatment compound into the one or more treatment probes, wherein the first treatment compound includes peroxone.

In yet another embodiment, the apparatus comprises a controller. The controller comprises a processor, a computer readable medium, and computer readable program code to operate the apparatus encoded in the computer readable medium. The computer readable program code comprises a series of computer readable program steps to effect injecting peroxone into one or more treatment probes disposed in the contaminated soil field.

### BRIEF DESCRIPTION OF THE DRAWINGS

FIG. 1 depicts the lateral view of a contamination field along an orthogonal dimension relative to the surface of the soil;

FIG. 2 depicts the lateral view a contamination field along a second orthogonal dimension relative to the surface of the soil;

FIG. 3 depicts the top view of a contamination field;

FIG. 4 presents a soil texture triangle used to classify the texture class of petroleum-contaminated soils;

FIG. 5 depicts a treatment grid for remediating contaminated soil;

FIGS. 6A, 6B, and 6C illustrate a top view of a contamination field indicating the placement of treatment shafts;

FIG. 7 a block diagram depicts one embodiment of a distribution network connected to one embodiment of a mobile treatment assembly;

FIG. 8 a block diagram depicts one embodiment of a mobile treatment assembly;

FIG. 9 depicts treatment probes disposed in a contamination field;

FIG. 10 depicts one embodiment of a treatment probe;

FIG. 11 is a flowchart summarizing the steps of Applicant's method for accessing the contamination field, creating a Remediation Work Plan, and inserting the treatment probes;

FIGS. 12, 13, and 14 are flowcharts summarizing the steps of one embodiment of Applicant's method for remediating a contamination field.

### DETAILED DESCRIPTION OF THE PREFERRED EMBODIMENTS

Applicant's apparatus and method using that apparatus comprises a mobile treatment system for the in situ remediation of soil contaminated with petroleum hydrocarbons. The Applicant's method comprises an oxidative process and in combination with bio-remediation ensures the elimination of contamination from the soil. Applicant's process comprises a rapid, non-intrusive method of soil remediation. Applicant's process rapidly brings soil quality back to natural levels.

As an example, a volume of soil having dimensions of 32′×80′×20′ deep contaminated with hydrocarbons can be remediated to show an 80 percent reduction in contamination in 48 hours, and comprise no remaining traces of contamination within one year (depending on site characteristics). The end products released into the environment by Applicant's method include oxygen, amino acids, water and carbon dioxide.

The process is environmentally safe and all end products are safe for humans and the environment. All materials used in the process are approved federally. The soil effects realized using Applicant's process are contained within the treatment area and does not affect surrounding areas.

Applicant's method comprises, inter alia, direct injection of air and liquid phase oxygen and water based oxidants into contaminated zones. Injection is effected using strategically located holes. The site preparation and treatment protocols are based on site specifics collected through an environmental site assessment.

Typically, Applicant's method realizes a reduction of 80 percent of hydrocarbon contamination within 48 hours, with bioremediation used thereafter resulting in undetectable contaminant levels within one year. In certain embodiments, Applicant's mobile system can treat up to 2560 sq ft (40 shafts 2-3″ diameter) up to 20 feet deep at once (˜51,200 cu ft of soil) with onsite work completed within about 48 hours depending on site specifics and weather conditions.

The Applicant's apparatus and method using that apparatus allows rapid soil reclamation where 51,200 cubic feet of soil (i.e. 32′ L×80′ W×20′ D) can be treated at once. Within 48 hours there will be an 80% reduction in the level of hydrocarbons in the soil with no trace of contaminants within about a year.

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

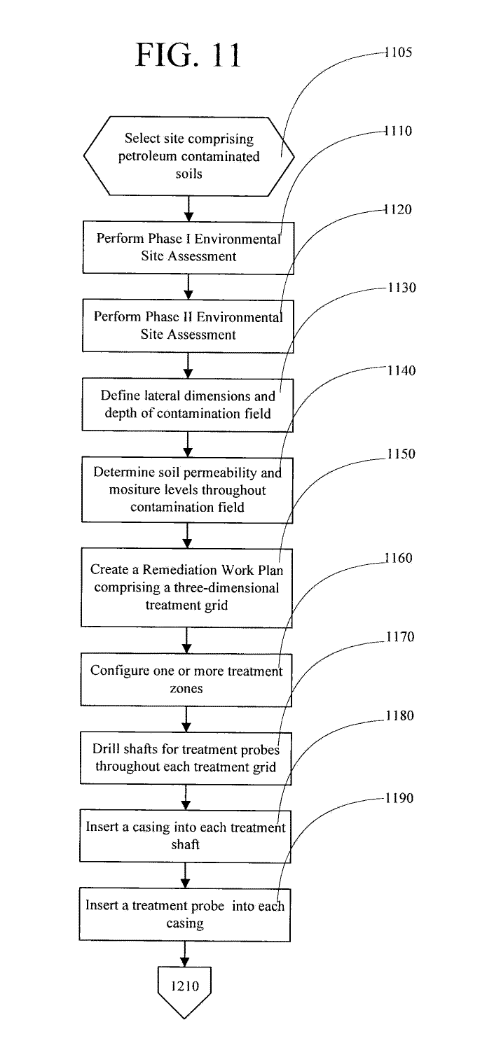

The schematic flow chart diagrams included are generally set forth as logical flow-chart diagrams (e.g., FIGS. 11, 12, 13, and 14). As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method (e.g., FIGS. 11, 12, 13, and 14). Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Applicant's invention is described herein in the context of remediating petroleum-contaminated soils. This description should not be taken as limiting. Rather, Applicant's apparatus and method may be utilized to cleanup soils contaminated with any one or more organic compounds, such as and without limitation, solvents, oils, lubricants, fuels, alkanes, alkenes, alkynes, esters, ethers, alcohols, aldehydes, ketones, carboxylic acids, amides, imides, sulfides, sulfoxides, sulfones, thiols, thioethers, isocyanates, thiocyanates, carbon-containing cyclic compounds, heterocyclic compounds, and mixtures thereof.

Applicant's apparatus and method are designed to be versatile, effective, and complete. Unlike traditional treatments, Applicant's apparatus comprises a self-contained mobile treatment assembly. Applicant's system is non-invasive, using individual treatment probes rather than damaging techniques. Applicant's treatment probes are connected to Applicant's mobile treatment assembly via a distribution network. Probes are placed into the soil and the treatment process begins. All treatment is done in the soil and no contamination ever enters the mobile treatment. The probes have to be positioned based on unique characteristics of each remediation situation.

The length of the treatment process is determined by the concentration of contamination in the soil, and the total volume of area contaminated. The treatment process involves multi-stage natural and environmentally friendly advanced oxidative treatments in the subsurface as well as bioremediation of the subsurface and surface. Following sub-surface treatment a surface treatment is performed to ensure complete remediation of the site. On-site testing of the soil and soil samples will be collected throughout the process to document the changes in contamination concentrations. Following treatment, the system is removed and samples are taken and tested to verify the soil quality and remediation levels.

Applicant's invention includes an apparatus and a method to remediate petroleum-contaminated soils. FIGS. 11, 12, 13, and 14, summarize the steps of Applicant's method. Referring now to FIG. 11, in step 1105 the method selects a site comprising petroleum contaminated soils. In certain embodiments, the site selected in step 1105 may comprise contaminated ground waters in addition to contaminated soils. In certain embodiments, such contaminated ground water comprises perched ground water. In certain embodiments, such contaminated ground water comprises a flowing subsurface aquifer.

In step 1110, the method performs a Phase I Environmental Site Assessment (“ESA”). In certain embodiments, the Phase I ESA of step 1110 includes performance of an on-site visit to view present conditions (chemical spill residue, die-back of vegetation, etc); hazardous substances or petroleum products usage (presence of above ground or underground storage tanks, storage of acids, etc.). In certain embodiments, the Phase I ESA of step 1110 includes an evaluation of any likely environmentally hazardous site history.

In certain embodiments, the Phase I ESA of step 1110 includes an evaluation of risks of neighboring properties upon the subject property In certain embodiments, the Phase I ESA of step 1110 includes a review of Federal, Provincial, State, Local and Tribal records out to distances ranging from about ⅛ mile to about 1 mile. In certain embodiments, the Phase I ESA of step 1110 includes interviews with persons knowledgeable regarding the property history, such as for example and without limitation past owners, present owner, key site manager, present tenants, neighbors, and the like.

In certain embodiments, the Phase I ESA of step 1110 includes an examination of municipal or county planning files to check prior land usage and permits granted. In certain embodiments, the Phase I ESA of step 1110 includes conducting file searches with public agencies (Provincial/State/County water board, fire department, health department, etc) having oversight relative to water quality and soil contamination issues. In certain embodiments, the Phase I ESA of step 1110 includes an examination of historic aerial photography of the vicinity. In certain embodiments, the Phase I ESA of step 1110 includes an examination of current United States Geological Survey (USGS) maps to scrutinize drainage patterns and topography. In certain embodiments, the Phase I ESA of step 1110 includes an examination of chain-of-title for Environmental Liens and/or Activity and Land Use Limitations (AULs).

In certain embodiments, the Phase I ESA of step 1110 is compliant with the requirements recited in ASTM E1527. In certain embodiments, the Phase I ESA of step 1110 is compliant with the requirements recited in ASTM E1528.

In step 1120, Applicant's method performs a Phase II Environment Site Assessment. As those skilled in the art will appreciate, the Phase II Environmental Site Assessment of step 1120 comprises an “intrusive” investigation which collects original samples of contaminated soils to analyze for quantitative values of various contaminants The most frequent substances tested are petroleum hydrocarbons, heavy metals, pesticides, solvents, and the like. In certain embodiments, the Phase II ESA of step 1120 is compliant with the requirements recited in ASTM E 1903.

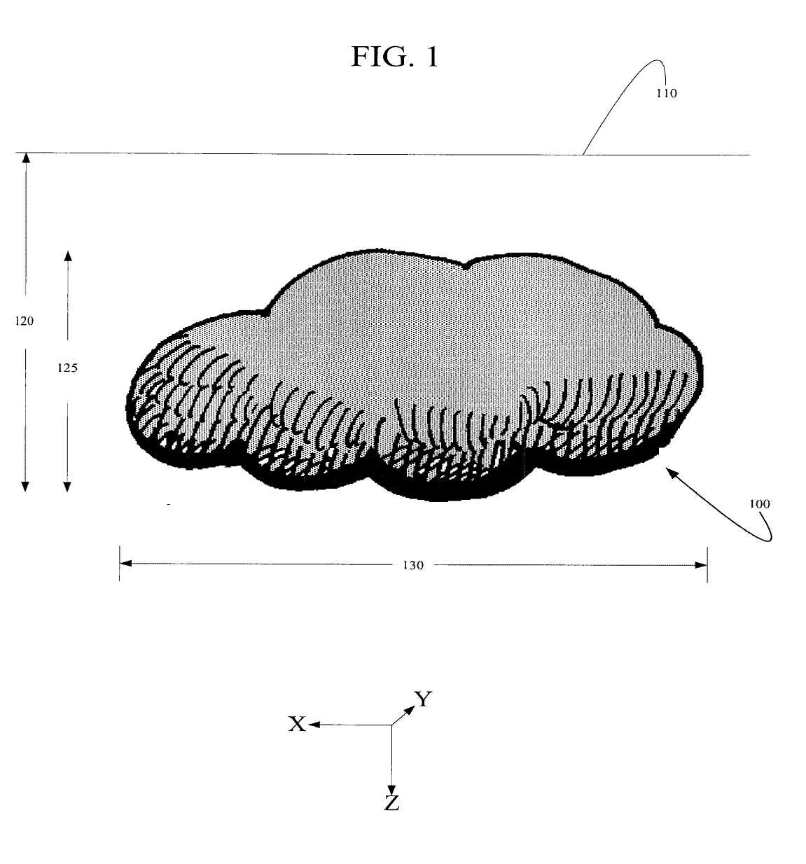

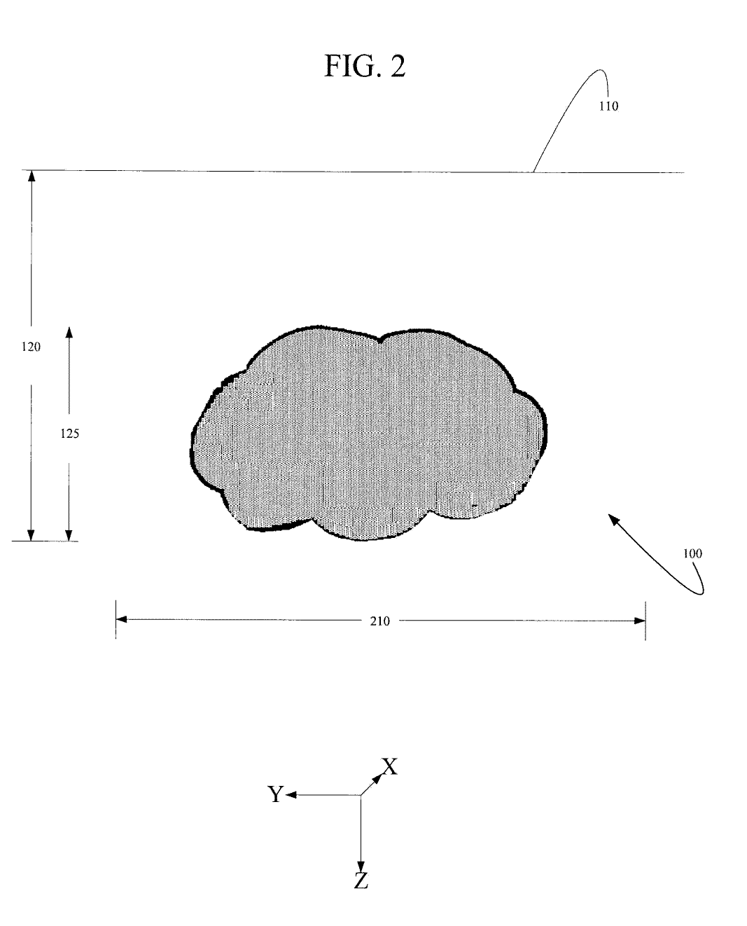

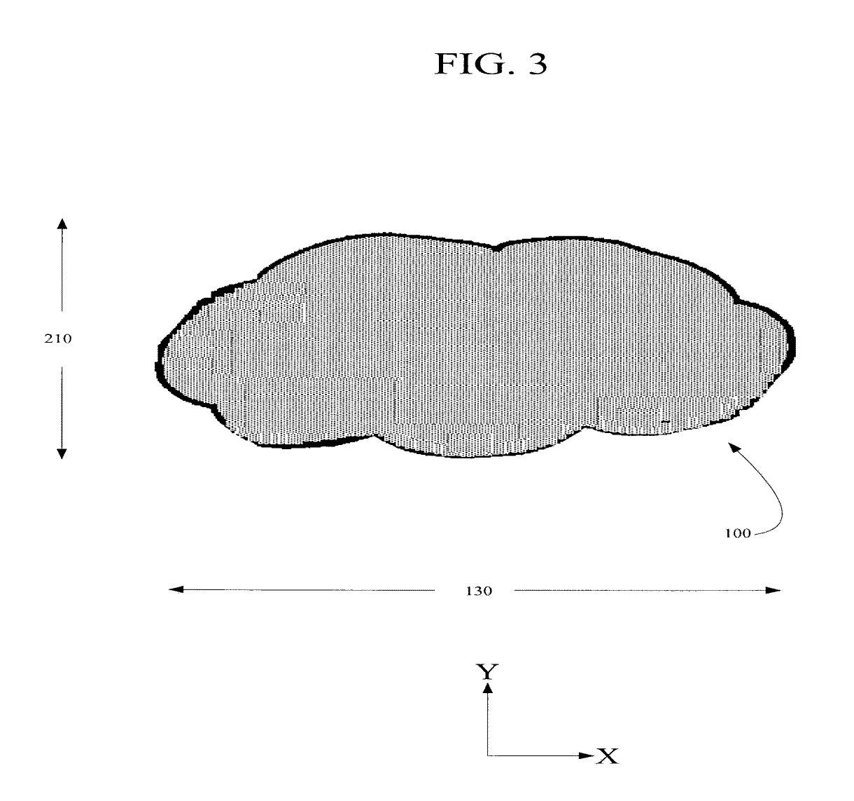

In step 1130, the method defines the lateral dimensions and depth of one or more contamination fields. For example, and referring now to FIGS. 1, 2, and 3, in step 1130 the method, using the results of the Phase II ESA of step 1120, defines a lateral dimension 130 along a first dimension, such as the X axis shown in FIG. 1. The method further in step 1130 determines a maximum subsurface depth 120 of contamination field 100 from the ground surface 110. FIG. 2 illustrates lateral dimension 210 along a second and orthogonal direction, i.e. along the Y axis, of contamination field 110. FIG. 3 shows a top view of contamination field 100 including the lateral dimensions 130 and 210.

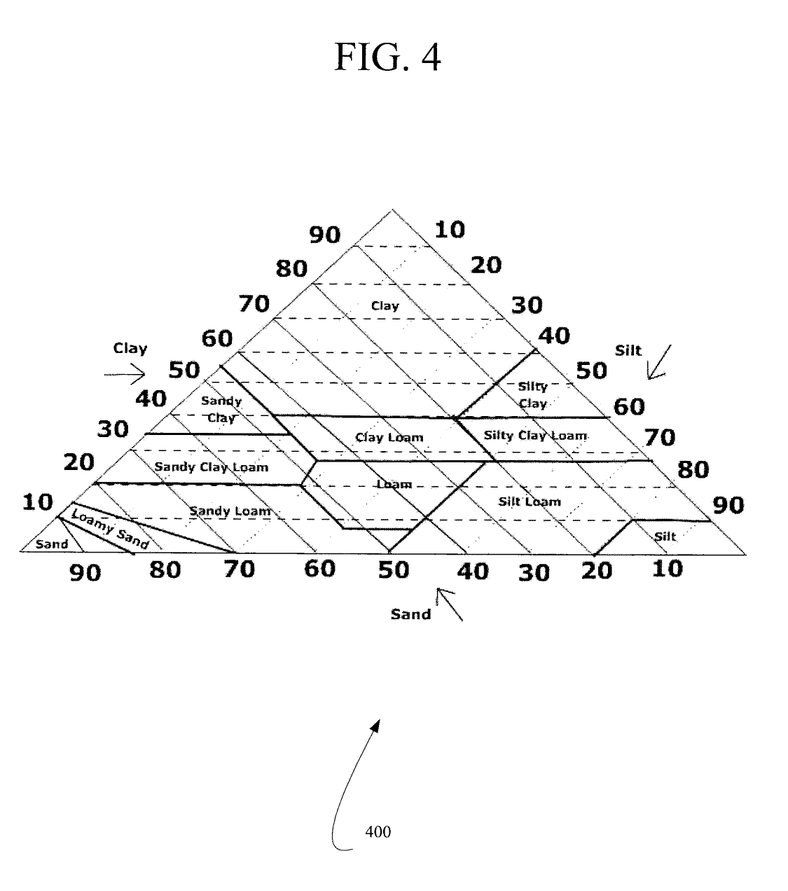

In step 1140, the method determines soil porosity and moisture. Soil texture refers to the relative proportion of sand, silt and clay size particles in a sample of soil. Clay size particles are the smallest being less than 0.002 mm in size. Silt is a medium size particle falling between 0.002 and 0.05 mm in size. The largest particle is sand with diameters between 0.05 for fine sand to 2.0 mm for very coarse sand. Soils that are dominated by clay are called fine textured soils while those dominated by larger particles are referred to as coarse textured soils. Soil textures can be divided into soil texture classes. Referring now to FIG. 4, soil texture triangle 400 is used to classify the texture class of petroleum-contaminated soils.

Soil texture controls many other properties like structure, chemistry, porosity, and permeability. Porosity of a soil is the volume of all the open spaces (pores) between the solid grains of soil. Soil permeability is the property of the soil pore system that allows fluid to flow therethrough. Generally, pore sizes and their connectivity determine whether a soil has high or low permeability. Fluids will flow more readily through soil with large pores with good interconnectivity between those pores. Smaller pores with the same degree of connectivity have lower permeability. Coarse textured soils tend to have large, well-connected pore spaces and hence high permeability.

Soil structure is the way soil particles aggregate together into what are called peds. Peds come in a variety of shapes depending on the texture, composition, and environment.

Granular, or crumb structures, look like cookie crumbs. They tend to form an open structure that allows fluids to penetrate the soil. Platy structure looks like stacks of dinner plates overlaying one another. Platy structure tends to impede the downward movement of fluids. Bulk density of a soil is calculated as the mass per unit volume including the pore space. Bulk density increases with clay content and is considered a measure of the compactness of the soil. The greater the bulk density, the more compact the soil. Compact soils have low permeability.

The total porosity of a porous medium is the ratio of the pore volume to the total volume of a representative sample of the medium. Assuming that the soil system is composed of three phases—solid, liquid (water), and gas (air)—where Vₛ is the volume of the solid phase, Vₗ is the volume of the liquid phase, V_{g} is the volume of the gaseous phase, Vₚ=Vₗ+V_{g} is the volume of the pores, and Vₜ=Vₛ+Vₗ+V_{g} is the total volume of the sample, then the total porosity of the soil sample, pₜ, is defined as follows:

$${p}_{t} = \frac{{V}_{p}}{{V}_{t}} = \frac{{V}_{l} + {V}_{g}}{{V}_{s} + {V}_{l} + {V}_{g}} . \qquad ( 3.1 )$$

Porosity is a dimensionless quantity and can be reported either as a decimal fraction or as a percentage. Table 1 lists representative total porosity ranges for various geologic materials. A more detailed list of representative porosity values (total and effective porosities) is provided in Table 2. In general, total porosity values for unconsolidated materials lie in the range of 0.25-0.7 (25%-70%). Coarse-textured soil materials such as gravel and sand tend to have a lower total porosity than fine-textured soils such as silts and clays. The total porosity in soils is not a constant quantity because the soil, particularly clayey soil, alternately swells, shrinks, compacts, and cracks.

TABLE 1
Range of Porosity Values

| | |
|---|---|
| Soil Type | Porosity, pₜ |

Unconsolidated deposits

| | |
|---|---|
| Gravel | 0.25-0.40 |
| Sand | 0.25-0.50 |
| Silt | 0.35-0.50 |
| Clay | 0.40-0.70 |

Rocks

| | |
|---|---|
| Fractured basalt | 0.05-0.50 |
| Karst limestone | 0.05-0.50 |
| Sandstone | 0.05-0.30 |
| Limestone, dolomite | 0.00-0.20 |
| Shale | 0.00-0.10 |
| Fractured crystalline | 0.00-0.10 |
| rock | |
| Dense crystalline | 0.00-0.05 |
| rock | |

Source: Freeze and Cherry (1979).

TABLE 2
Representative Porosity Values

| | Total Porosity, pₜ | | Effective Porosity, pₑ | |
|---|---|---|---|---|
| | | Arithmetic | | Arithmetic |
| Material | Range | Mean | Range | Mean |

Sedimentary material

| | | | | |
|---|---|---|---|---|
| Sandstone (fine) | — | — | 0.02-0.40 | 0.21 |
| Sandstone (medium) | 0.14-0.49 | 0.34 | 0.12-0.41 | 0.27 |
| Siltstone | 0.21-0.41 | 0.35 | 0.01-0.33 | 0.12 |
| Sand (fine) | 0.25-0.53 | 0.43 | 0.01-0.46 | 0.33 |
| Sand (medium) | — | — | 0.16-0.46 | 0.32 |
| Sand (coarse) | 0.31-0.46 | 0.39 | 0.18-0.43 | 0.30 |
| Gravel (fine) | 0.25-0.38 | 0.34 | 0.13-0.40 | 0.28 |
| Gravel (medium) | — | — | 0.17-0.44 | 0.24 |
| Gravel (coarse) | 0.24-0.36 | 0.28 | 0.13-0.25 | 0.21 |
| Silt | 0.34-0.51 | 0.45 | 0.01-0.39 | 0.20 |
| Clay | 0.34-0.57 | 0.42 | 0.01-0.18 | 0.06 |
| Limestone | 0.07-0.56 | 0.30 | ~0-0.36 | 0.14 |

Wind-laid material

| | | | | |
|---|---|---|---|---|
| Loess | — | — | 0.14-0.22 | 0.18 |
| Eolian sand | — | — | 0.32-0.47 | 0.38 |
| Tuff | — | — | 0.02-0.47 | 0.21 |

Igneous rock

| | | | | |
|---|---|---|---|---|
| Weathered granite | 0.34-0.57 | 0.45 | — | — |
| Weathered gabbro | 0.42-0.45 | 0.43 | — | — |
| Basalt | 0.03-0.35 | 0.17 | — | — |

Metamorphic rock

| | | | | |
|---|---|---|---|---|
| Schist | 0.04-0.49 | 0.38 | 0.22-0.33 | 0.26 |

As those skilled in the art will appreciate, the effective porosity, pₑ, also called the kinematic porosity, of a porous medium is defined as the ratio of the part of the pore volume where the fluid can circulate to the total volume of a representative sample of the medium. In naturally porous systems such as subsurface soil, where the flow of fluid is caused by the composition of capillary, molecular, and gravitational forces, the effective porosity can be approximated by the specific yield, or drainage porosity, which is defined as the ratio of the volume of fluid drained by gravity from a saturated representative sample of the soil to the total volume of the sample.

The definition of effective (kinematic) porosity is linked to the concept of pore fluid displacement rather than to the percentage of the volume occupied by the pore spaces. The pore volume occupied by the pore fluid that can circulate through the porous medium is smaller than the total pore space, and, consequently, the effective porosity is always smaller than the total porosity. In a saturated soil system composed of two phases (solid and liquid) where (1) Vₛ is the volume of the solid phase, (2) V_{w}=(V_{w}+V_{mw}) is the volume of the liquid phase, (3) V_{iw} is the volume of immobile pores containing the fluid adsorbed onto the soil particle surfaces and the fluid in the dead-end pores, (4) V_{mw} is the volume of the mobile pores containing fluid that is free to move through the saturated system, and (5) Vₜ=(Vₛ+V_{iw}+V_{mw}) is the total volume, the effective porosity can be defined as follows:

$$\text{?} = \frac{{V}_{mw }}{{V}_{t}} = \frac{{V}_{mw}}{{V}_{s} + {V}_{mw} + {V}_{iw}} . \\ \text{?} \text{indicates text missing or illegible when filed} \qquad ( 4.1 )$$

Another soil parameter related to the effective soil porosity is the field capacity, ᵣ, also called specific retention, irreducible volumetric fluid content, or residual fluid content, which is defined as the ratio of the volume of fluid retained in the soil sample, after all downward gravity drainage has ceased, to the total volume of the sample. Considering the terms presented above for a saturated soil system, the total porosity pₜ and the field capacity ᵣ can be expressed, respectively, as follows:

$$\begin{matrix} {p}_{t} = \frac{{V}_{mw} + {V}_{iw}}{\text{?}} & ( 42 ) \\ {θ}_{γ} = \frac{{V}_{iw}}{\text{?}} . \\ \text{?} \text{indicates text missing or illegible when filed} & ( 4.3 )\end{matrix}$$

Therefore, the effective porosity is related to the total porosity and the field capacity according to the following expression:

pₑ=pₜ−θ_{γ}. (4.4)

Several aspects of the soil system influence the value of its effective porosity: (1) the adhesive fluid on minerals, (2) the absorbed fluid in the clay-mineral lattice, (3) the existence of unconnected pores, and (4) the existence of dead-end pores. The adhesive fluid in the soil is that part of the fluid present in the soil that is attached to the surface of the soil grains through the forces of molecular attraction. The sum of the volumes of the adhesive and absorbed fluid plus the fluid that fills the unconnected and dead-end pores constitute the volume of the adsorbed fluid, V_{iw}, that is unable to move through the system.

Determination of the effective porosity, pₑ, of soils can be accomplished indirectly by measuring the total porosity, pₜ, and the field capacity, ᵣ, and then calculating pₑ from Equation 4.4. The total porosity is obtained indirectly by measuring the soil densities.

To determine the field capacity of the soils, the soil sample is first saturated with fluid and is then allowed to drain completely under the action of gravity until it gets to its irreducible saturation. The value of ᵣ can then be obtained according to the methods used for measuring volumetric fluid content.

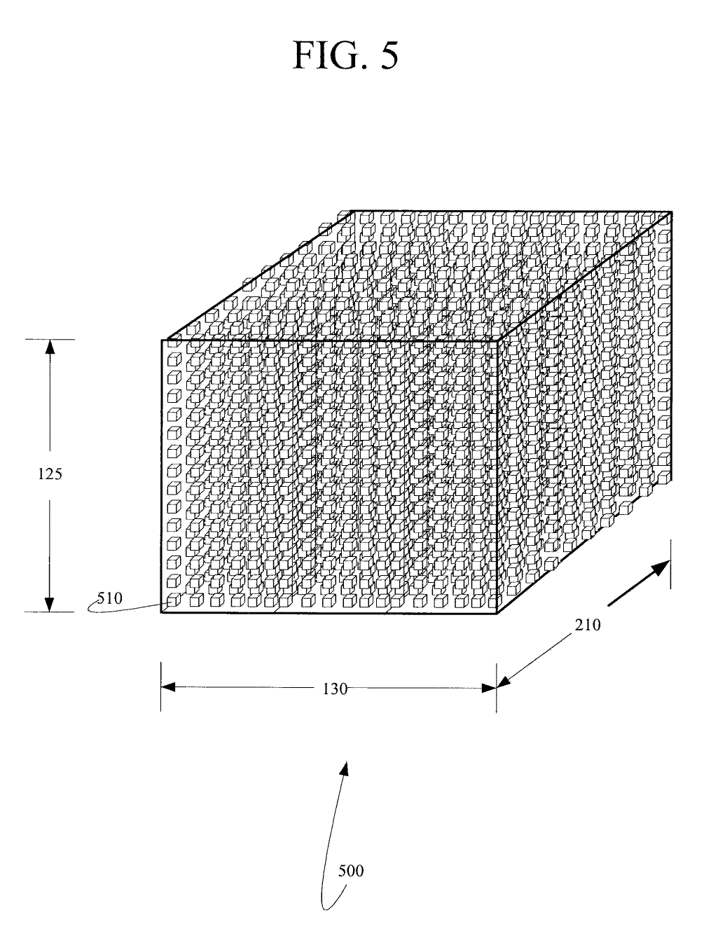

In step 1150, the method, based upon the soil contamination levels determined in step 1130 and based upon the soil porosity determination of step 1140, creates a Remediation Work Plan comprising a three-dimensional treatment grid. For example and referring now to FIG. 5, treatment grid 500 comprises a plurality of datapoints disposed throughout a three-dimensional volume of soil comprising contamination field 100. Treatment grid 500 is defined by the dimensions of contamination field 100, including lateral dimensions 130 and 210, and height 125, of the contamination field 100.

Treatment grid 500 comprises a plurality of individual datapoints 510 disposed throughout the three-dimensional matrix. Each datapoint comprises concentration levels found for each soil contaminant in the Phase II ESA of step 1120. The Remediation Work Plan includes target soil cleanup levels for treatment grid 500.

Applicant's remediation controller 800, described hereinbelow, utilizes the plurality of datapoints comprising treatment grid 500 and the target soil cleanup levels, to determine the quantities of various remediation reagents, such as for example, ambient air, 100 percent gaseous oxygen, liquid peroxone, bacteria systems, and the like, to deliver to different portions of treatment grid 500.

In certain embodiments, each datapoint 510 recites contamination levels for a soil portion comprising about a 1 cubic inch volume. In certain embodiments, each datapoint 510 recites contamination levels for a soil portion comprising about a 1 cubic foot volume. In certain embodiments, each datapoint 510 recites contamination levels for a soil portion comprising about a 9 cubic feet volume. In certain embodiments, each datapoint 510 recites contamination levels for a soil portion comprising about a 25 cubic feet volume.

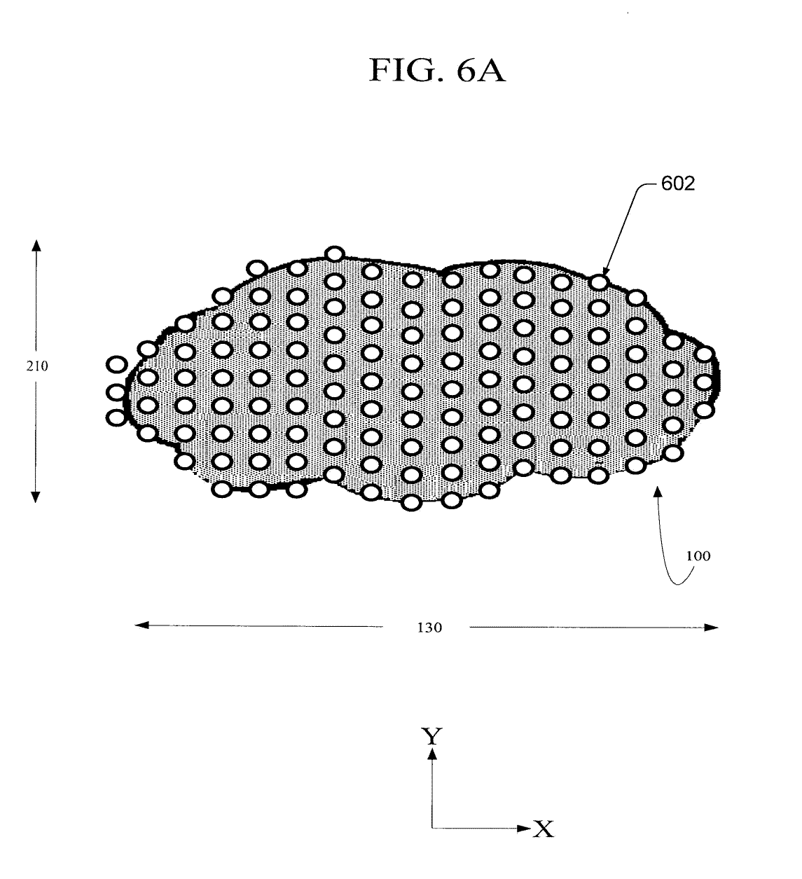

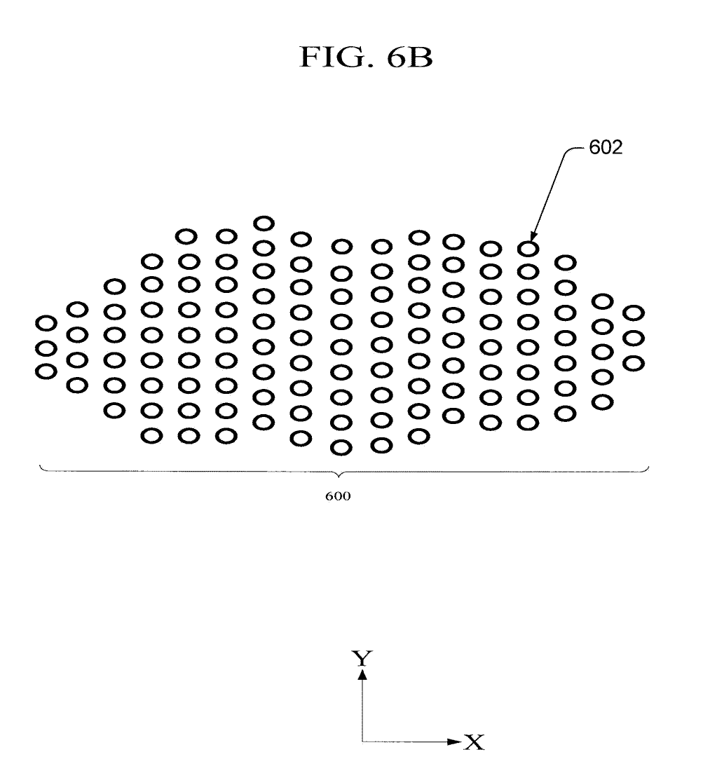

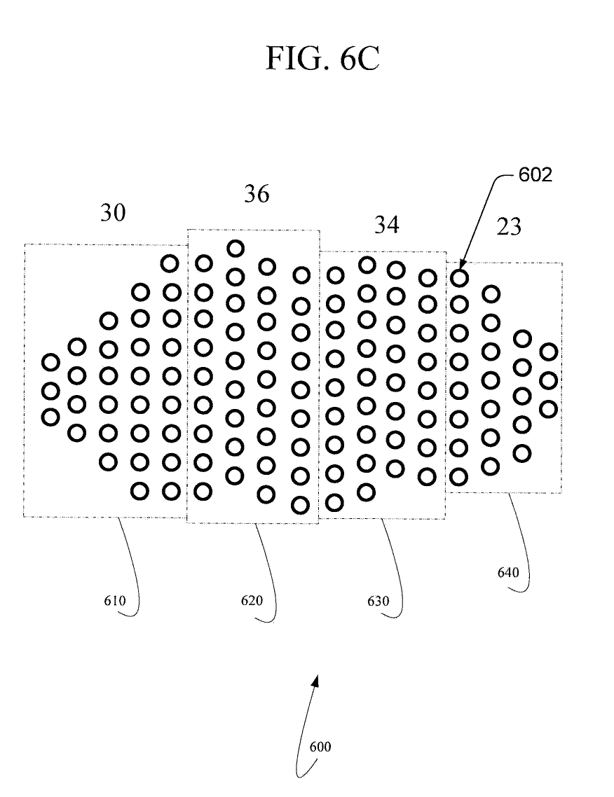

In step 1160, the method, using the treatment grid of step 1150, determines a number of treatment zones. Referring now to FIGS. 6A, 6B, and 6C, FIG. 6A illustrates proposed placement of subsurface treatment shafts 602 placed throughout the lateral dimensions 130 and 210 of subsurface contamination field 100. FIG. 6B shows the subsurface treatment shafts 602.

FIG. 6C shows the subsurface treatment shafts 602 of FIG. 6B divided into four different treatment zones, namely treatment zones 610, 620, 630, and 640. In certain embodiments, each of the treatment zones of step 1160 comprise fewer than 40 individual treatment shafts. For example in the illustrated embodiment of FIG. 6C, treatment zone 610 comprises 30 treatment shafts, treatment zone 620 comprises 36 treatment shafts, treatment zone 630 comprises 34 treatment shafts, and treatment zone 640 comprises 23 treatment shafts.

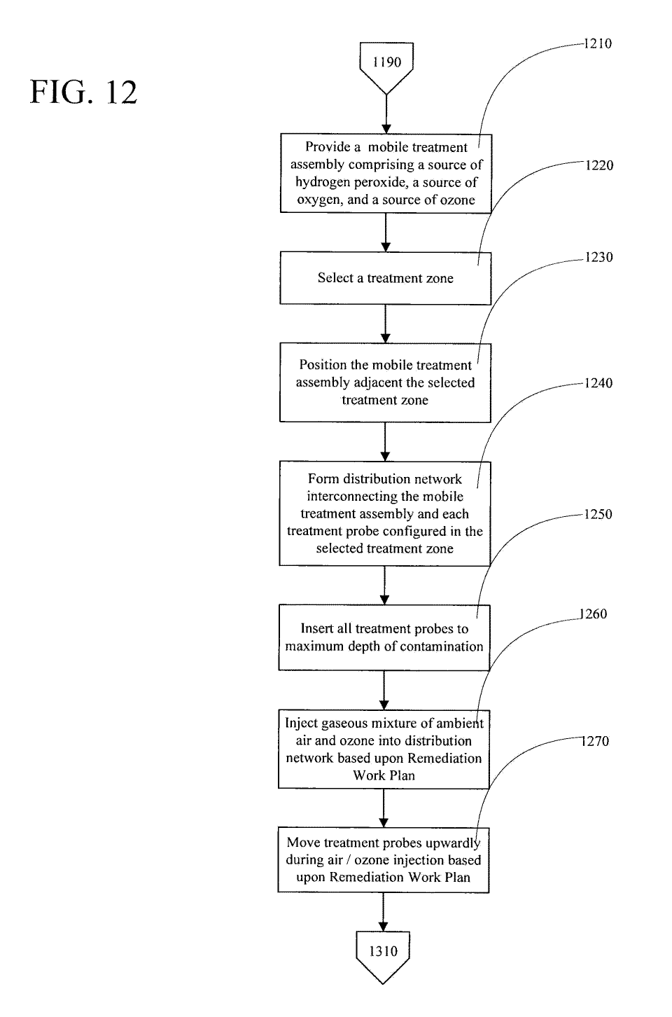

In step 1170, the method drills a plurality of shafts extending downwardly from the surface of the site of step 1105, wherein each shaft corresponds to a location specified in FIG. 6B. In step 1180, the method inserts a casing into each treatment shaft drilled in step 1170. In step 1190, the method inserts a treatment probe into each casing placed in step 1180. The method transitions from step 1190 to step 1210 (FIG. 12).

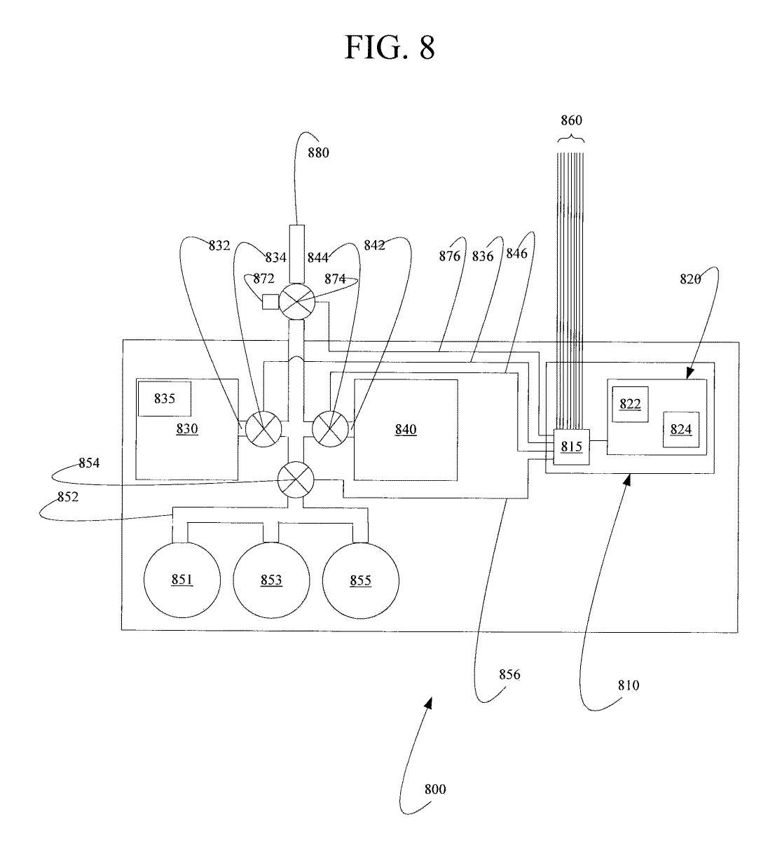

Referring now to FIG. 12, in step 1210 the method provides a mobile treatment assembly comprising a source of hydrogen peroxide, a source of oxygen, and a source of ozone. FIG. 8 illustrates mobile treatment assembly 800. In the illustrated embodiment of FIG. 8, mobile treatment assembly 800 comprises a controller 810, a source of ozone 830, a source of hydrogen peroxide 840, and a source of oxygen comprising a plurality of pressurized cylinders 851, 853, and 855 comprising oxygen under pressure.

In the illustrated embodiment of FIG. 8, controller 810 comprises processor 815, computer readable medium 820, operating system/microcode 822 encoded in computer readable medium 820, and computer readable program code 824 encoded in computer readable medium 820. Processor 815 utilizes computer readable program code 824 to implement one or more steps of Applicant's method described herein. Computer readable program code 824 comprises a series of instructions to implement Applicant's Remediation Work Plan of step 1150 (FIG. 11).

In the illustrated embodiment of FIG. 8, mobile treatment assembly 800 comprises ozone generation unit 830. In certain embodiments, unit 830 comprises a corona discharge generator which generates ozone on-site. Ozone generation unit 830 is interconnected to ozone plenum 832. Ozone plenum 832 is interconnected to valve 834. In certain embodiments, valve 834 is interconnected by communication link 836 to processor 815 disposed in controller 810. In these embodiments, processor 815 utilizes computer readable program code 824 to control the volume of ozone released from plenum 832 by valve 834.

In the illustrated embodiment of FIG. 8, mobile treatment assembly 800 further comprises source of hydrogen peroxide 840. In certain embodiments, source 840 comprises a storage tank for 4 percent hydrogen peroxide in water. Hydrogen peroxide source 840 is interconnected to hydrogen peroxide plenum 842. Hydrogen peroxide plenum is interconnected to valve 844. In certain embodiments, valve 844 is interconnected by communication link 846 to processor 815 disposed in controller 810. In these embodiments, processor 815 utilizes computer readable program code 824 to control the volume of hydrogen peroxide solution released from hydrogen peroxide source 840 by valve 844.

In the illustrated embodiment of FIG. 8, mobile treatment assembly 800 further comprises oxygen cylinders 851, 853, and 855. Cylinders 851, 853, and 855, are interconnected to oxygen plenum 852. Oxygen plenum 852 is interconnected to valve 854. In certain embodiments, valve 854 is interconnected by communication link 856 to processor 815 disposed in controller 810. In these embodiments, processor 815 utilizes computer readable program code 824 to control the volume of oxygen released from plenum 852 by valve 854.

In the illustrated embodiment of FIG. 8, mobile treatment assembly 800 further comprises intake port 872. In certain steps, Applicant's method intakes ambient air using intake port 872. In certain embodiments, Applicant's method intakes a bacteria system disposed in water using intake port 872.

Intake port 872 is interconnected to valve 874. In certain embodiments, valve 874 is interconnected by communication link 876 to processor 815 disposed in controller 810. In these embodiments, processor 815 utilizes computer readable program code 824 to control the volume of ambient air released into discharge port 880.

Valves 834, 844, 854, and 874, control the volume of ozone, hydrogen peroxide solution, oxygen, and ambient air, respectively, released by mobile treatment assembly 800 from discharge port 880. Valves 834, 844, 854, and 874, can be operated independently of one another. As a result, any combination of ozone, hydrogen peroxide solution, oxygen, and ambient air, can be discharged from discharge port 880. In certain embodiments, one or more of valves 834, 844, 854, and 874, can be operated manually. In certain embodiments, one or more of valves 834, 844, 854, and 874, can be operated by processor 815 disposed in controller 810. In these processor-operated embodiments, processor 815 utilizes Applicant's Remediation Work Plan of step 1150, wherein that Remediation Work Plan is encoded as computer readable program code 824 in computer readable medium 820, to automatically implement one or more of the steps of Applicant's soil remediation method described herein.

Applicant's mobile treatment assembly 800 can transport to the site of petroleum contaminated soils all of the materials needed to remediate those contaminated soils to governmentally-approved residual contaminant levels. In certain embodiments, Applicant's mobile treatment assembly 800 is disposed in a powered, wheeled vehicle, such as and without limitation a tractor trailer assembly, a flatbed truck, a modified recreational vehicle, and the like. In certain embodiments, Applicant's mobile treatment assembly 800 is disposed in a wheeled vehicle, i.e. a trailer, wherein that trailer can be releaseably attached to powered vehicle and thereby transported to the site of step 1105.

In embodiments wherein Applicant's mobile treatment assembly 800 is moved to a site of petroleum-contaminated soils, wherein that site does not have a source of water, Applicant's mobile treatment assembly further comprises a source of potable water in addition to the elements described hereinabove.

Referring again to FIG. 12, in step 1220 the method selects a treatment zone. For example, FIG. 6C shows the site of step 1105 divided into four different treatment zones. In step 1230, the method positions the mobile assembly of step 1210 adjacent to the selected treatment zone of step 1220.

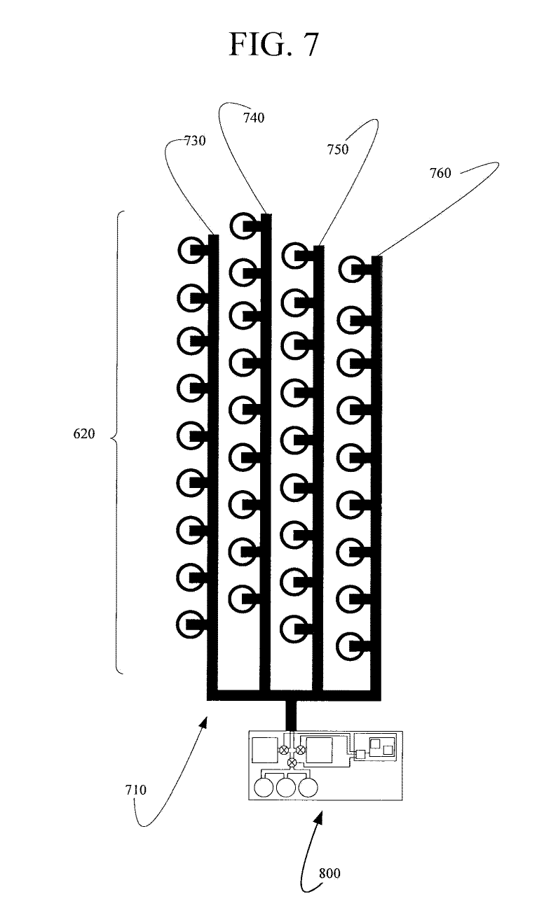

In step 1240, the method forms a distribution network interconnecting the mobile treatment assembly of step 1210 and the selected treatment zone of step 1220. FIG. 7 illustrates a distribution network 710 interconnecting treatment zone 620 (FIG. 6C) with Applicant's mobile treatment assembly 800 (FIG. 8). Distribution network 710 is interconnected to output port 880 (FIG. 8) disposed in Applicant's mobile treatment assembly 800 (FIG. 8). In the illustrated embodiment of FIG. 7, distribution network 710 comprises a first distribution portion 730, a second distribution portion 740, a third distribution portion 750, and a fourth distribution portion 760.

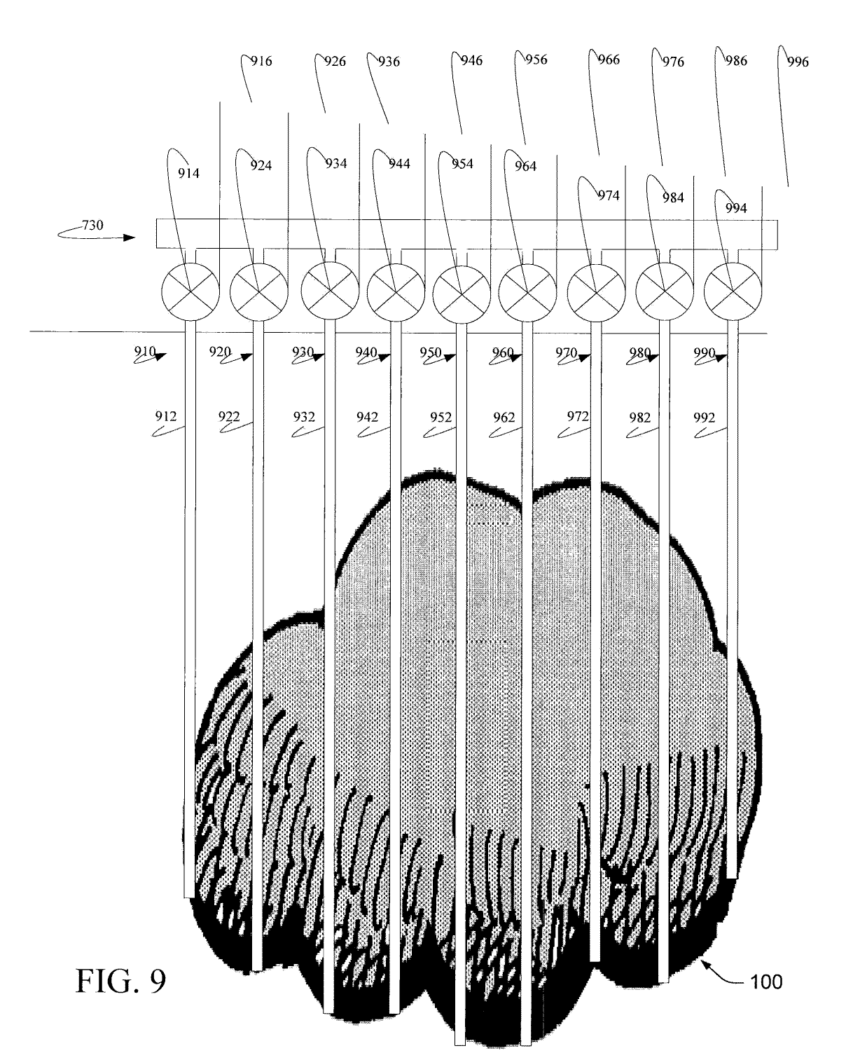

In step 1250, the method inserts the treatment probes disposed in the selected treatment zone of step 1220 to a maximum depth of contamination. FIG. 9 illustrates treatment probes 910, 920, 930, 940, 950, 960, 970, 980, and 990, wherein those probes comprise distribution portion 730 (FIG. 7) of distribution network 710 (FIG. 7). Treatment probes 910, 920, 930, 940, 950, 960, 970, 980, and 990, comprise probe shafts 912, 922, 932, 942, 952, 962, 972, 982, and 992, respectively. Materials provided to distribution system 710 (FIG. 7) by Applicant's mobile treatment assembly 800 (FIG. 8) are delivered to probes 910, 920, 930, 940, 950, 960, 970, 980, and 990, via delivery subsystem 730, and are released into contamination field 100 through the distal ends of probe shafts 912, 922, 932, 942, 952, 962, 972, 982, and 992, respectively.

In certain embodiments, treatment probes 910, 920, 930, 940, 950, 960, 970, 980, and 990, further comprise valves 914, 924, 934, 944, 954, 964, 974, 984, and 994, respectively. In these embodiments, valves 914, 924, 934, 944, 954, 964, 974, 984, and 994, control the amount of materials provided by Applicant's mobile treatment assembly 800 (FIG. 8), and delivered by distribution system 710 (FIG. 7), via distribution subsystem 730 (FIGS. 7, 9).

In certain embodiments, valves 914, 924, 934, 944, 954, 964, 974, 984, and 994, respectively, are in communication with processor 815 disposed in controller 810 (FIG. 8) via communication links 916, 926, 936, 946, 956, 966, 976, 986, and 996, respectively. In these embodiments, communication links 916, 926, 936, 946, 956, 966, 976, 986, and 996, interface with a plurality of communication links 860 (FIG. 8), wherein the plurality of communication links 860 are interconnected to processor 815 (FIG. 8). Further in these embodiments, processor 815, using Applicant's Remediation Work Plan of step 1150 encoded as computer readable program code 824, operates valves 914, 924, 934, 944, 954, 964, 974, 984, and 994, respectively, to deliver a pre-determined amount of ambient air, and/or ozone, and/or hydrogen peroxide solution, and/or oxygen, to specific portions of treatment grid 500 (FIG. 5).

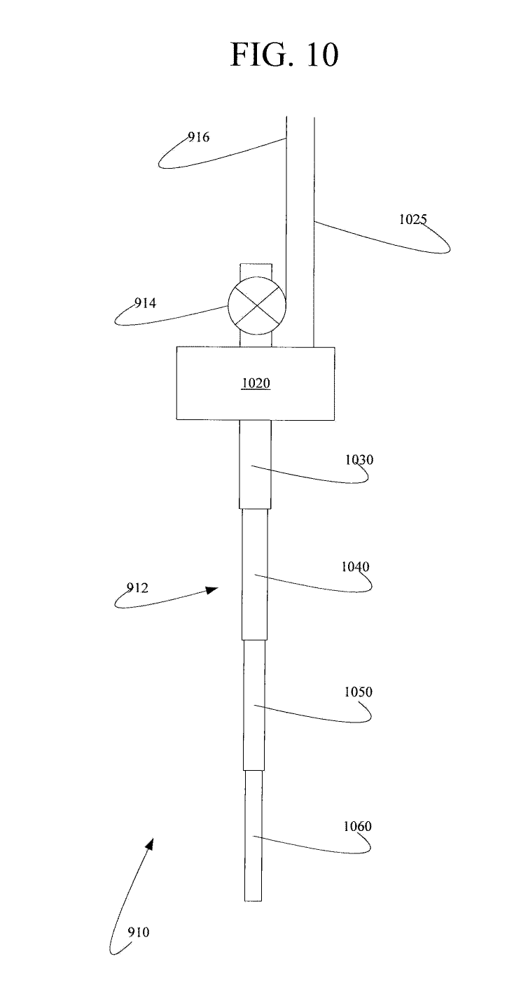

In the illustrated embodiment of FIG. 9, each of treatment probes 910, 920, 930, 940, 950, 960, 970, 980, and 990, extend downwardly from the surface of the site of step 1105 to a maximum depth of contamination. FIG. 10 illustrates one embodiment of treatment probe 910. Treatment probe 910 comprises tubular shaft 912 and valve 914 (FIGS. 9, 10), wherein valve 914 is in communication with controller 810 (FIG. 8) via communication link 916. In the illustrated embodiment of FIG. 10, tubular shaft 912 comprises motor/servo 1020 and a plurality of telescoping shaft segments 1030, 1040, 1050, and 1060, interconnected to motor/servo 1020. Further in the illustrated embodiment of FIG. 10, motor/servo 1020 is in communication with controller 810 (FIG. 8) via communication link 1025. In these embodiments, processor 820, utilizing Applicant's Remediation Work Plan encoded as computer readable program code 824 in computer readable medium 820, can cause motor/servo 1020, increase or decrease the length of treatment probe shaft 912 by causing telescoping probe shaft segment 1040 to extend inwardly into or extend outwardly from segment 1030, and/or by causing telescoping probe shaft segment 1050 to extend inwardly into or extend outwardly from segment 1040, and/or by causing telescoping probe shaft segment 1060 to extend inwardly into or extend outwardly from segment 1050.

In step 1260, Applicant's method introduces from Applicant's mobile treatment assembly 800 (FIG. 8) a gaseous mixture of ambient air and ozone into distribution network 710 (FIG. 7). That ozone/ambient air mixture is introduced into the treatment zone selected in step 1220 using the plurality of treatment probes disposed in that selected treatment zone.

The total volume of an ozone mixture injected into each portion of contamination field 100 is a function of the size of the treatment area and level of contamination, and is determined by Applicant's Remediation Work Plan.

Ozone (O₃) rapidly breaks back down to oxygen (O₂) in subsurface soils while oxidizing petroleum contaminants to carbon dioxide. In addition, the ozone/ambient air mixture injected into contamination field 100 in step 1260 conditions the soil through desiccation, oxidation of contaminants, and soil oxygenation.

In addition, the ozone/ambient air mixture injected into contamination field 100 in step 1260 inhibits microbial elements which negatively effect subsequent bioremediation, creates an aerobic environment, and reduces the oxidative demand of the soil which allows subsequent injection of peroxone to react more efficiently and effectively with soil contaminants.

In certain embodiments, in step 1260 the method generates ozone using ozone source 830, and mixes that ozone with ambient air from intake port 872, to form a 1.5 volume/volume percent mixture of ozone and ambient air. The method further in step 1260, introduces an ozone/ambient air mixture into a selected treatment zone 620 (FIG. 6C) using distribution network 710 (FIG. 7).

In certain embodiments, Applicant's method in step 1260 forms an ozone/ambient air mixture comprising more than 1.5 volume percent ozone. In certain embodiments. Applicant's method in step 1260 forms an ozone/ambient air mixture comprising less than 1.5 volume percent ozone.

In step 1270, the method moves a plurality of treatment probes disposed in the selected treatment zone upwardly based upon Applicant's Remediation Work Plan. In certain embodiments, the plurality of treatment probes disposed in the selected treatment zone are manually moved upwardly. In certain embodiments, in step 1270 controller 810 (FIG. 8) disposed in Applicant's mobile treatment assembly 800 causes individual motors/servos 1020 (FIG. 10) disposed in each treatment probe to move a telescoping treatment shaft 912 upwardly.

In certain embodiments, in step 1270 each treatment probe disposed in the selected treatment zone is moved about five (5) feet upwardly. In certain embodiments, in step 1270 each treatment probe disposed in the selected treatment zone is moved less than five (5) feet upwardly. In certain embodiments, in step 1270 each treatment probe disposed in the selected treatment zone is moved more than five (5) feet upwardly.

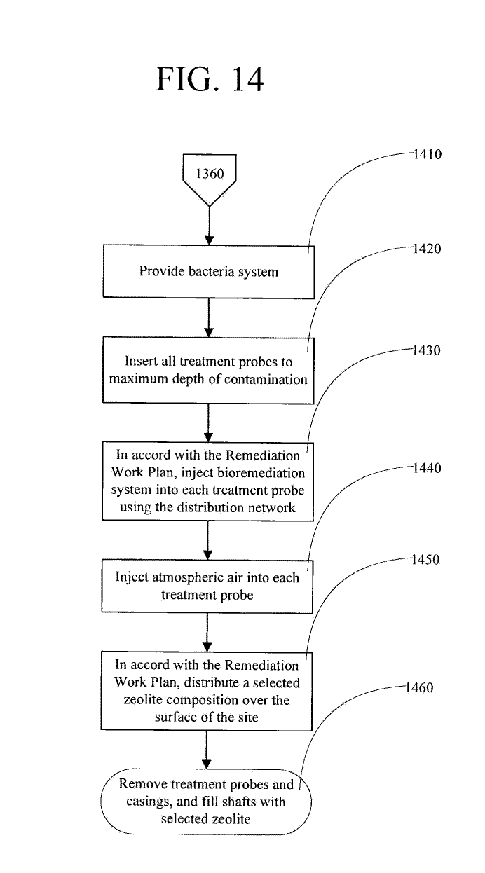

Steps 1260 and 1270 are repeated sequentially until a gaseous mixture of ambient air and ozone has been injected into the entire contamination field 100. Thereafter, the method transitions to step 1310 (FIG. 14).

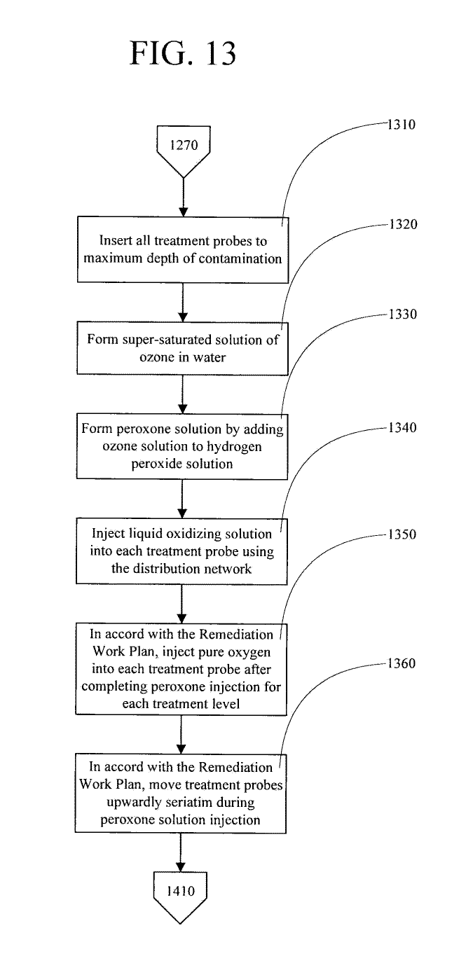

Referring now to FIG. 13, in step 1310 the method inserts all treatment probes in the selected treatment zone to a maximum depth of contamination. In the illustrated embodiment of FIG. 9, each of treatment probes 910, 920, 930, 940, 950, 960, 970, 980, and 990, extend downwardly from the surface of the site of step 1105 to a maximum depth of contamination.

In certain embodiments, in step 1310 the treatment probes disposed in the selected treatment zone are manually lowered to a maximum depth of contamination. In certain embodiments, processor 820, utilizing Applicant's Remediation Work Plan encoded as computer readable program code 824 in computer readable medium 820, can cause a motor/servo 1020 (FIG. 10) disposed in each treatment probe to increase the length of a treatment probe shaft 912 (FIGS. 9, 10) disposed in each treatment probe by causing telescoping probe shaft segment 1040 (FIG. 10) to extend outwardly from segment 1030, and/or by causing telescoping probe shaft segment 1050 (FIG. 10) to extend outwardly from segment 1040, and/or by causing telescoping probe shaft segment 1060 (FIG. 10) to extend outwardly from segment 1050.

In step 1320, the method forms a super-saturated solution of ozone in water. In certain embodiments, ozone is formed by ozone generator 830, and that gaseous ozone is added to water in vessel 835.

In step 1330, the method forms peroxone solution by adding the saturated ozone solution of step 1320 to hydrogen peroxide. In certain embodiments, the saturated ozone solution formed in vessel 835 is added to hydrogen oxide solution provided from hydrogen peroxide source 840 to form a peroxone solution.

In step 1340, the method introduces the peroxone solution of step 1330 into a distribution system, such as for example distribution system 710 (FIG. 7), such that the peroxone solution of step 1330 is injected into the selected treatment zone of step 1220, such as treatment zone 620, via the treatment probes disposed in that selected treatment zone.

Peroxone (H₂O₃) is formed from two natural oxidants: Hydrogen Peroxide (H₂O₂) and Ozone (O₃). Peroxone increases the overall oxidative power of hydrogen peroxide (H₂O₂) (1.8 V) and ozone (O₃) (2.1 V) to that of the hydroxyl radical (2.8 V). In certain embodiments, peroxone III is formed in the Applicant's mobile treatment assembly by adding a 4% hydrogen peroxide solution I into water super-saturated with ozone II formed onsite. The basic equation (v) for formation of peroxone is:

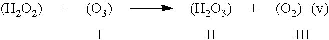

Subsurface injection of peroxone (H₂O₃) allows for the introduction of hydroxyl radicals into contamination field 100. Peroxone oxidizes hydrocarbons, including alkanes, alkenes, and aromatic ring-containing materials, to produce as reaction products water, oxygen and carbon dioxide using reactions (i) and (ii), and/or reactions (iii) and (iv). Direct oxidation via Hydroxyl Radical and Hydrogen Peroxide

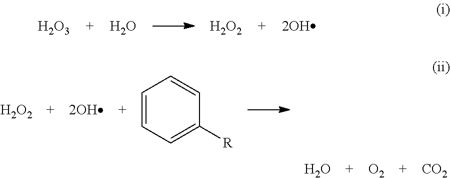

### Direct Oxidation Via Hydroxyl Radical and Ozone

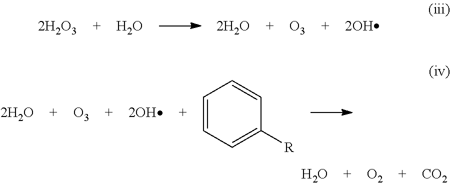

wherein R is —H (benzene), —CH₃ (Toluene), —CH₂CH₃ (Ethylbenzene), and Dimethyl (ortho-Xylene, meta-Xylene, and para-Xylene).

In step 1350, the method in accord with Applicant's Remediation Work Plan of step 1150 injects pure oxygen into each treatment probe disposed in the selected treatment zone before adjusting the length of those treatment probes. By “pure oxygen,” Applicant means 100 percent oxygen.

In step 1360, the method moves a plurality of treatment probes disposed in the selected treatment zone upwardly based upon Applicant's Remediation Work Plan. In certain embodiments, the plurality of treatment probes disposed in the selected treatment zone are manually moved upwardly. In certain embodiments, in step 1360 controller 810 (FIG. 8) disposed in Applicant's mobile treatment assembly 800 causes individual motors/servos 1020 (FIG. 10) disposed in each treatment probe to move a telescoping treatment shaft 912 upwardly.

In certain embodiments, in step 1360 each treatment probe disposed in the selected treatment zone is moved about five (5) feet upwardly. In certain embodiments, in step 1360 each treatment probe disposed in the selected treatment zone is moved less than five (5) feet upwardly. In certain embodiments, in step 1360 each treatment probe disposed in the selected treatment zone is moved more than five (5) feet upwardly.

Steps 1330, 1340, 1350, and 1360, are repeated sequentially until a peroxone solution followed by pure oxygen has been injected into the entire contamination field 100. Thereafter, the method transitions to step 1410 (FIG. 14).

In step 1410, the method provides a bacteria system. Applicant's bacteria system comprises petroleum-eating bacteria. Applicant's bacteria system comprises a dry powder which is re-circulated and grown in oxygenated water comprising 2-3 ppm oxygen for 24 hours while being fed a combination of organic nutrients, which enable a large colony count of bacteria (10⁸ to 10⁹ CFU per milliliter). Every 3 pounds of bacteria culture is combined with 5 gallons of bio-nutrient in 300 gallons of non-chlorinated, oxygenated water. In certain embodiments, Applicant's bio system comprises Arthrobacter globiformis, Arthrobacter citreus, Nitrosomonas, Nitrobacter, Bacillus licheniformis, Bacillus amyloloquefaciens, Bacillus subtilis, Bacillus megaterium, and Bacillus pumilus. Arthrobacters comprise gram positive, aerobic rods that constitute a large portion of the aerobic chemoheterotrophic population of soil bacteria. In certain embodiments, Applicant's bio system further comprises sea weed cream, Leonardite extract, fish parts, and combinations thereof.

In step 1420, the method inserts all treatment probes disposed in the selected treatment zone to a maximum depth of contamination. In certain embodiments, in step 1420 the treatment probes disposed in the selected treatment zone are manually lowered to a maximum depth of contamination. In certain embodiments, processor 820, utilizing Applicant's Remediation Work Plan encoded as computer readable program code 824 (FIG. 8) in computer readable medium 820 (FIG. 8), can cause a motor/servo 1020 (FIG. 10) disposed in each treatment probe to increase the length of a treatment probe shaft 912 (FIGS. 9, 10) disposed in each treatment probe by causing telescoping probe shaft segment 1040 (FIG. 10) to extend outwardly from segment 1030, and/or by causing telescoping probe shaft segment 1050 (FIG. 10) to extend outwardly from segment 1040, and/or by causing telescoping probe shaft segment 1060 (FIG. 10) to extend outwardly from segment 1050.

In step 1430, the method provides the bacteria system of step 1410. The bacteria system of step 1410 facilitates natural breakdown of subsurface contamination to carbon dioxide (CO₂), oxygen (O₂), water (H₂O), and inert substances (i.e. amino acids)

In step 1440, the method injects ambient air into the selected treatment zone via each of the treatment probes disposed in the selected treatment zone. The oxygenation process of step 1440 is used to ensure healthy and complete colonization of the bacteria and an aerobic environment for bio-remediation. The flow rate of ambient air used will range based on site characteristics, number of treatment probes, and depth of the treatment shafts. In certain embodiments, the flow rate of ambient air in step 1430 is about 1 SCFM per treatment probe.

In step 1450, the method distributes a selected zeolite composition over the surface of the site of step 1105. Zeolites are microporous, aluminosilicate minerals. Zeolites comprise a porous structure that can accommodate a wide variety of Cations, such as Na⁺, Ca²⁺, Mg²⁺ and others. These positive ions are rather loosely held and can readily be exchanged for others in a contact solution. Some of the more common mineral zeolites are analcime, chabazite, clinoptilolite, heulandite, natrolite, phillipsite, and stilbite. An example mineral formula is: Na₂Al₂Si₃O₁₀-2H₂O, the formula for natrolite.

Natural zeolites form where volcanic rocks and ash layers react with alkaline groundwater. Zeolites also crystallize in post-depositional environments over periods ranging from thousands to millions of years in shallow marine basins. Naturally occurring zeolites are rarely pure and are contaminated to varying degrees by other minerals, metals, quartz, or other zeolites.

The one or more zeolites applied in step 1450 are selected based upon the chemistry of the surface soils at the site of step 1105. These one or more zeolites are selected to promote growth of plants, bushes, and/or trees, at that site.

Steps 1220, 1230, 1240, 1250, 1260, 1270, 1310, 1320, 1330, 1340, 1350, 1360, 1410, 1420, 1430, 1440, 1450, and 1460, are repeated for each treatment zone configured in step 1160. In certain embodiments of Applicant's method, a plurality of treatment zones are remediated sequentially, i.e. one after the other, using a single mobile treatment assembly 800 (FIG. 8). In certain embodiments, a plurality of treatment zones are remediated simultaneously using a corresponding plurality of mobile treatment assemblies.

### Example

The Example summarizes an in situ application of Applicant's mobile oxidation process to a site comprising 64 cubic yards of soil contaminated with about 20 liters of diesel fuel. An oxygen (O₂) and ozone (O₃) mixture was run at 15 L/min for 48 hrs with ozone (O₃) produced and mixed at a rate of 1 gram per hour giving a 1.5% (v/v) ozone to atmospheric air concentration. A total of 48 grams of ozone were applied over the 48 hours.

At the end of the treatment timeframe, no hydrocarbons, and slight ozone concentration (<0.007 ppm) was detected onsite. Atmospheric air was injected into the soil for 20 minutes to eliminate any residual ozone in the soil. Table I recites the soil contamination pre- and post-oxidation treatment.

TABLE I

| | | PRE | POST | Background |
|---|---|---|---|---|
| Benzene | mg/kg | 0.052 | <0.004 | 0.002 |
| Toluene | mg/kg | 2.16 | <0.005 | 0.002 |
| Ethylbenzene | mg/kg | 5.85 | <0.010 | 0.002 |
| Total Xylenes (m, p, o) | mg/kg | 24.4 | <0.010 | 0.002 |
| F1 C6-C10 | mg/kg | 6820 | <4 | NV |
| F1 -BTEX | mg/kg | 6790 | <4 | NV |
| F2c C10-C16 | mg/kg | 16500 | 61 | NV |
| F3c C16-C34 | mg/kg | 12400 | 257 | NV |
| F4c C34-C50 | mg/kg | 55 | 37 | NV |
| F4HTGCc C34-C50+ | mg/kg | 55 | 56 | NV |

NOTE:
1 mg/kg = 1 ug/g = 1 ppm.
NV stands for no value derived for F1 to F4 hydrocarbons in background environments.

The various steps or acts in a method or process may be performed in the order shown, or may be performed in another order. For example, in certain implementations, individual steps recited in FIGS. 11, 12, 13, and 14 may be eliminated or reordered.

Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods to implement the present invention.

It is understood that the examples and implementations described herein are for illustrative purposes only and that various modifications or changes in light thereof will be suggested to persons skilled in the art and are to be included within the spirit and purview of this application.

I claim:

1. An apparatus for remediating contaminated soil, comprising:
a source of peroxone;
a plurality of treatment probes for insertion into said contaminated soil; and
a distribution network configured to connect said plurality of treatment probes with said source of peroxone.

2. The apparatus of claim 1, further comprising a controller, wherein said controller is configured to:
control a valve operatively disposed on said source of peroxone, wherein said valve controls a flow of peroxone from said source of peroxone; and
control a plurality of valves operatively disposed on said plurality of treatment probes, wherein said plurality of valves are configured to control said flow of peroxone from said plurality of treatment probes.

3. The apparatus of claim 2, wherein:
each of said plurality of treatment probes comprise a plurality of telescoping shaft segments;
each of said plurality of treatment probes has a length;
the plurality of telescoping shaft segments are configured to allow said length to be adjusted; and
said controller is configured to adjust said length.

4. The apparatus of claim 2, further comprising a mobile platform, wherein:
said source of peroxone and said controller are disposed on said mobile platform.

5. The apparatus of claim 2, wherein the source of peroxone includes a source of ozone and a source of hydrogen peroxide.

6. The apparatus of claim 2, further comprising a source of petroleum-eating bacteria, wherein:
said distribution network connects said plurality of treatment probes with said source of petroleum-eating bacteria; and
said controller is configured to control a flow of a petroleum-eating bacteria from said source of petroleum-eating bacteria.

7. The apparatus of claim 6, wherein said petroleum-eating bacteria includes at least one of Arthrobacter globiformis, Arthrobacter citreus, Nitrosomonas, Nitrobacter, Bacillus licheniformis, Bacillus amyloloquefaciens, Bacillus subtilis, Bacillus megaterium, or Bacillus pumilus.

8. The apparatus of claim 5, further comprising:
a remediation treatment, wherein said remediation treatment comprises a treatment mixture and a treatment amount for each of a plurality of treatment locations, wherein:
said treatment mixture comprises ozone from said ozone source and hydrogen peroxide from said hydrogen peroxide source;
said plurality of treatment locations are disposed in a three-dimensional space, wherein said three-dimensional space is defined by the dimensions of a soil contamination field; and
said controller is further configured to deliver said treatment mixture and said treatment amount to each of said plurality of treatment locations.

9. The apparatus of claim 8, further comprising a source of oxygen, wherein:
said remediation treatment further comprises a second treatment mixture and a second treatment amount;
said second treatment mixture comprises oxygen from said source of oxygen; and
said controller is further configured to deliver said second treatment mixture and said second treatment amount to each of said plurality of treatment locations.

10. The apparatus of claim 9, further comprising a source of petroleum-eating bacteria, wherein:
said remediation treatment further comprises a third treatment mixture and a third treatment amount;
said third treatment mixture comprises petroleum-eating bacteria from said source of petroleum-eating bacteria; and
said controller is further configured to deliver said third treatment mixture and said third treatment amount to each of said plurality of treatment locations.

11. A method for remediating contaminated soil, the method comprising:
inserting one or more treatment probes into a contaminated soil field; and
injecting peroxone into said one or more treatment probes.

12. The method of claim 11, further comprising reacting hydrogen peroxide and ozone at the situs of said contaminated soil field to form said peroxone.

13. The method of claim 11, further comprising mixing a super-saturated solution of ozone in water with hydrogen peroxide to form said peroxone.

14. The method of claim 11, wherein the method further includes injecting oxygen into said one or more treatment probes.

15. The method of claim 14, wherein the method further includes in the following order;
injecting, prior to said peroxone, ambient air and ozone into said one or more treatment probes;
injecting petroleum-eating bacteria into said one or more treatment probes; and
injecting ambient air into said one or more treatment probes.

16. The method of claim 11, wherein:
said contaminated soil field has a maximum depth and a minimum depth;
said inserting is performed at one or more surface locations; and
said injecting is performed at each of a plurality of treatment locations between the maximum depth and the minimum depth for each of said one or more surface locations.

17. An apparatus comprising a controller comprising a processor, a computer readable medium, and computer readable program code for remediating contaminated soil encoded in said computer readable medium, said computer readable program code comprising a series of computer readable program steps to effect injecting peroxone into one or more treatment probes disposed in said contaminated soil field.

18. The apparatus of claim 17, further comprising:
a source of ozone; and
a source of hydrogen peroxide, wherein said computer readable program further comprises a series of computer readable program steps to effect reacting said ozone with said hydrogen peroxide to form said peroxone.

19. The apparatus of claim 18, further comprising:
a source of ambient air; and
a source of oxygen, wherein said computer readable program further comprises a series of computer readable program steps to effect:
injecting ambient air from said source of ambient air into one or more treatment probes disposed in said contaminated soil field; and
injecting oxygen from said source of oxygen into one or more treatment probes disposed in said contaminated soil field;
